(19) United States
(12) Patent Application Publication
(10) Pub. No.: US 2026/0234324 A1
(43) Pub. Date: Aug. 13, 2026

(54) MODIFIED COPOLYESTERS HAVING IMPROVED DROP IMPACT, METHODS FOR MAKING THE SAME, AND MOLDED ARTICLES MADE THEREFROM

(71) Applicant: ALPEK POLYESTER USA, LLC, Charlotte, NC (US)

(72) Inventors: Kazem Majdzadeh ARDAKANI, Charlotte, NC (US); Damian Adrian SALAZAR HERNANDEZ, Charlotte, NC (US); Barry L. WEST, Charlotte, NC (US); Peter S. KEZIOS, Charlotte, NC (US)

(73) Assignee: ALPEK POLYESTER USA, LLC, Charlotte, NC (US)

(21) Appl. No.: 19/155,833

(22) PCT Filed: Oct. 7, 2024
(86) PCT No.: PCT/US2024/050219

§ 371 Date: Aug. 12, 2025

Related U.S. Application Data
(60) Provisional application No. 63/588,522, filed on Oct. 6, 2023.

(51) Int. Cl. C08G 63/199; C08G 63/183; C08G 63/85

(52) U.S. Cl. CPC C08G 63/199; C08G 63/183; C08G 63/85

(57) ABSTRACT

A copolyester is provided containing a diacid/diester component having from 70 to 99 mol % terephthalic units, and from 1 to 30 mole % of non-terephthalic based diacid/diester units, based on total diacid/diester component, and a diol component having from 1 to 15 mole % of a diol containing a cyclohexylene group, and from 82 to 99 mole % ethylene glycol, and from 0 to 3 mole % diethylene glycol (DEG), based on total diol component, articles made therefrom and methods of making the copolyester.

### CROSS REFERENCE TO RELATED APPLICATIONS

The present application is related to, and claims priority to, U.S. Provisional Application Ser. No. 63/588,522, filed Oct. 6, 2023.

### BACKGROUND OF THE INVENTION

### Field of the Invention

The present invention relates to copolyester compositions having both non-terephthalic based diacid units and diol units having a cyclohexylene group therein, particularly those derived from cyclohexanedimethanol (CHDM), resulting in a copolyester having improved drop impact properties, articles having improved drop impact made therefrom, and methods for making the copolyester compositions.

### Description of the Related Art

Polyester resins including resins such as poly(ethylene terephthalate) (PET), poly(butylene terephthalate) (PBT), poly(ethylene naphthalate) (PEN), poly(trimethylene terephthalate) (PTT), and poly(trimethylene naphthalate) (PTN), are conventionally used as resins in the manufacture of containers such as beverage bottles. Properties such as flexibility, good impact resistance, and transparency, together with good melt processability, permit polyester resins to be widely used for this application.

Because of the challenge of achieving high IV with PET based polyesters in a cost effective, time-efficient manner, and due to the increased crystallinity that often results from the thermal history, PET resins have typically been limited to use in injection stretch blow molding to prepare products such as soda bottles or other thin wall containers.

One of the main requirements for injection blow molded or extrusion blow molded (EBM) containers is their ability to withstand being dropped while holding a liquid without experiencing any container breakage. PET faces a performance challenge in terms of drop impact failure, particularly in the case of aged containers produced in injection blow molding and extrusion blow molding processes where little orientation occurs. Converters often use high density polyethylene (HDPE) in these applications.

To enhance the drop impact properties of polyester, previous approaches involved using a significant amount of co-monomers as impact modifiers, branching agents, and fillers. (See, e.g., U.S. Pat. Nos. 4,132,707; 4,999,388; 6,740,377; 7,025,925; 7,915,374; 9,815,964; and US Published application No. 20030096942). However, these solutions introduce additional problems during processing of the polymers produced, adversely affect the properties of the containers and/or may render the material not recyclable using the customary recycling channels. In particular, high levels of impact modifiers pose challenges for recycling in the post-consumer recycling stream. Furthermore, in the case of high-level modification with an impact modifier, the impact performance tends to noticeably deteriorate as the material ages. The presence of branching comonomers and inorganic fillers can result in poor container appearance, melt fracture at the die, and issues with recyclability. There is currently believed to be no solution available that effectively addresses the issue of drop impact failure in fresh and aged containers without resorting to additives and/or significantly modifying the formulation with impact modifiers, which may affect recyclability and the drop impact performance of aged materials. All of the previously suggested solutions have included reformulating the polymer with chain extenders, branchers, addition of inorganics (silica), and high levels of impact modifiers, which inevitably impact the operating window for processing, the material properties and present a challenge for the recycling of containers under conventional PET recycling stream processes.

Therefore, finding a novel copolyester composition with a low to moderate modification that meets all requirements, including appearance, oxygen barrier properties, recyclability, and improved fresh and aged drop impact performance is highly desirable.

### SUMMARY OF THE INVENTION

One object of the present invention is to provide a copolyester composition that provides improved drop impact performance in fresh and aged containers, while maintaining other properties required of the material for the particular end use.

A further object of the present invention is to provide a copolyester composition that can meet the melt strength characteristics of an EBM or injection blow molded container without the need for addition of crosslinking agents or other additives.

Another object of the present invention is to provide a copolyester composition that can be readily processed in conventional PET recycling routes, because of low to moderation modification of the polymer backbone without the addition of additives or branchers/crosslinkers.

Another object of the present invention is to provide a copolyester composition that can maintain a slow crystallization rate during cooling of the injection or extrusion blow molding process to maintain container wall clarity without haziness.

A further object of the present invention is to provide a copolyester composition that can maintain barrier properties required in a container formed therefrom, for use in various food, beverage, and/or medical applications.

Another object of the present invention is to provide articles prepared from the copolyester composition by way of injection or extrusion blow molding.

Another object of the present invention is to provide methods for producing the copolyester composition of the present invention.

These and other objects and advantages of the invention, either alone or in combinations thereof, may be satisfied by a copolyester comprising:
a diacid/diester component comprising from 70 to 99 mol % terephthalic units and from 1 to 30 mole % non-terephthalic based diacid/diester units, based on total diacid/diester component, and
a diol component comprising from 1 to 15 mole % of a diol containing a cyclohexylene group, and from 82 to 99 mole % ethylene glycol, and from 0 to 3 mole % diethylene glycol (DEG), based on total diol component, articles formed therefrom, and a method for production of the copolyester composition.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 provides a graphical representation of the drop impact failure rate of plaques produced from copolyesters using various concentrations of CHDM (from 0.5 wt % % to 2.4 wt % %) in combination with IPA.

### DETAILED DESCRIPTION OF THE PREFERRED EMBODIMENTS

The present invention relates to a copolyester comprising a diacid/diester component comprising from 70 to 99 mol % terephthalic units and from 1 to 30 mole % of non-terephthalic based diacid/diester units, based on total diacid/diester component, and a diol component comprising from 1 to 15 mole % of a diol containing a cyclohexylene group, and from 82 to 99 mole % ethylene glycol, and from 0 to 3 mole % diethylene glycol (DEG), based on total diol component.

The present inventors have found that the addition of low concentrations of a diol containing a cyclohexylene group combined with a non-terephthalic based diacid/diester unit, such as isophthalic acid (IPA), succinic acid, adipic acid, etc, at any concentration can significantly enhance the impact properties of injection blow molded or extrusion blow molded containers and reduces the crystallization rate. Within the context of the present invention, the term “cyclohexylene” refers to a di-substituted cyclohexyl group as shown below:

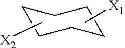

where each of X₁ and X₂ contain a hydroxyl group (—OH) and may contain other linking atoms between the hydroxyl group and the cyclohexane ring, and the X₁ and X₂ groups can be in the 1,2-, 1,3-, or 1,4-positions on the cyclohexane ring. Diols containing a cyclohexylene group include, but are not limited to, one of the cyclohexanedimethanol compounds, including 1,2-cyclohexanedimethanol, 1,3-cyclohexanedimethanol, 1,4-cyclohexanedimethanol and combinations thereof (hereafter referred to collectively as “CHDM”). The description below will refer to the diol containing a cyclohexylene unit as CHDM, and the diacid/diester component as IPA, but it is to be understood that this diol can be other than a CHDM compound and the non-terephthalic based diacid/diester can be other than IPA. This improvement can be achieved without the need for substantial modifications to the polymerization or the molding processes, and without the need for other comonomers or additives (although low levels of such comonomers and/or additives may be desirable depending on the ultimate end use for the copolyester composition of the present invention).

Although not wishing to be bound by any particular mechanism of action, the present inventors note that cyclohexane molecules (part of CHDM) can exist in both chair and boat conformations. The presence of both boat and chair conformers in the polymer backbone is believed to have a noticeable effect on chain packing and sub-Tg (glass transition temperature) motions. Numerous studies have explored the correlation between enhanced impact properties and secondary relaxations, particularly with cyclohexylene structures. These structures have demonstrated a considerable enhancement of sub-Tg transitions in dynamic mechanical analysis (DMA) around −60° C. The present invention shows that the incorporation of diols containing a cyclohexylene group, such as CHDM, at optimized low levels and its interaction with IPA (or other non-terephthalic based diacid/diester units, which have a tendency to cause brittleness in modified PET copolyesters otherwise) play a vital role in achieving these improved properties. By using this mechanism at optimum levels, the present invention improves the resilience and durability of PET-based articles by using a combination of comonomers at low and moderate levels of CHDM and IPA. By leveraging the flexibility introduced into the polymer chains, the present invention is believed to reduce chain packing and introduce sub-Tg motions, thus improving the impact properties of the articles made from the present invention copolyesters without compromising other properties. Thus, with the present invention, it is no longer necessary to incorporate higher levels of impact modifiers or other additives that can have adverse effects on the appearance, processing and recyclability of products produced therefrom.

Copolyester resins for the copolyester compositions of the present invention are generally made by a combined esterification/polycondensation reaction between monomer units of a diol (e.g., ethylene glycol (EG)) and a dicarboxylic acid (e.g., terephthalic acid (TPA)). The terms carboxylic acid and/or dicarboxylic acid and/or diacid, as used herein, include ester derivatives of the carboxylic acid and dicarboxylic acids. Esters of carboxylic acids and dicarboxylic acids may contain one or more C₁-C₆ alkyl groups (e.g., methyl, ethyl, propyl, iso-propyl, butyl, iso-butyl, tert-butyl, pentyl, hexyl and mixtures thereof) in the ester unit, for example, dimethyl terephthalate (DMT).

The copolyester compositions of the present invention may be formed, for example, by first producing a prepolymer of low molecular weight and low intrinsic viscosity (IV) (e.g., a mixture of oligomers), for example, by reacting a diol and a diacid (or diester) in a melt phase reaction. The formation of the oligomers may be carried out by reacting a slurry of diol and diacid/diester monomer units in an esterification (or transesterification in the case of using diester monomers instead of diacid monomer units) reactor. (while the following description is written from the standpoint of using dicarboxylic acid starting monomers, it is to be understood that a similar process is used when starting with dicarboxylic acid ester, or diester, starting monomers, with certain differences in the conditions for the transesterification reaction compared to the direct esterification reaction, such as in the catalysts, temperatures, etc used; such differences are well within the knowledge of one of ordinary skill in the art). EG may be lost to evaporation during the esterification reaction which may be carried out at high temperatures. Therefore the slurry of diol and dicarboxylic acid may contain an excess of EG, for example the diol and dicarboxylic acid may be present in a molar ratio of from about 1.2 to about 2.5 based on the total glycol to total di-acid. Further pre-polycondensation and polycondensation of the oligomers can be carried out to provide a resin mixture having an IV of from 0.50 to 0.65. Such resin mixtures are suitable in various applications such as fibers/filaments, fiber chips, or bottle-resin precursors. Amorphous clear base chips having an IV of from 0.50 to 0.65 may be subjected to solid-state polymerization (SSP) to increase the molecular weight (e.g., to an IV of from 0.72 to 0.76 for water bottle applications, 0.81 to 0.85 for CSD/Beer bottles, etc.). The solid-state polymerization (SSP) process unit can result in the resin undergoing crystallization which forms opaque pellets.

A continuous polyester melt-phase polycondensation process usually consists of three reaction steps: (i) esterification to form low molecular weight oligomers, (ii) pre-polymerization of the oligomers to form a pre-polymer, and (iii) polycondensation to form a polymer with an intermediate molecular weight or intrinsic viscosity (e.g., a target intrinsic viscosity of from 0.50 to 0.85).

The three reaction steps (i), (ii), and (iii) above, can be carried out to achieve the target intrinsic viscosity in from 2 to 6 reactors using existing melt-phase process technology. In general, esterification is conducted in one or two vessels to form a mixture of low molecular weight oligomers with a low degree of polymerization (e.g., about up to 5 to 10 monomer unit pairs reacted). The oligomers are then pumped to one or two pre-polymerization vessels where higher temperatures and lower pressures aid in removing water and EG. The degree of polymerization then increases to a level of 10 to 40 repeating units. The temperatures are further increased and pressures are further reduced in the final one or two vessels to form a polymer ready to be cut into pellets for example, or to be spun directly into fibers or filaments.

Esterification and pre-polymerization vessels may be agitated. Polycondensation vessels (e.g., finishers, wiped-film reactors etc.) may have agitators designed to generate very thin films. Temperatures and hold-up times are optimized for each set of vessels to minimize the degradation and other side reactions. Some by-products that may be generated by the polyester melt phase reaction include diethylene glycol (DEG), acetaldehyde, water, cyclic oligomers, carboxyl end groups, vinyl end groups, and anhydride end groups.

Both time and temperature are two variables that are preferably controlled during an esterification/polycondensation reaction. With higher reaction temperatures, the total reaction time is significantly reduced and less residence time and/or fewer reactors are needed.

Alternatively to such a continuous production method, polyesters may be prepared using a batch method. In a batch method the diol and dicarboxylic acid units are mixed together in a single reactor. In some cases more than one reactor (e.g., reaction vessel) may be used if necessary. The diol/dicarboxylic acid mixture is heated to cause the monomer units to undergo a condensation reaction. The by-products of the condensation reaction may include water or an alcohol. By conducting the reaction under reduced pressure or by subjecting the reaction mixture to reduced pressure during the final stages of the reaction, volatile by-products of the reaction can be removed thus driving the reaction to completion.

Certain physical and chemical properties of polymeric materials are negatively affected by long exposure to elevated temperature, especially if the exposure is in an oxygen-containing atmosphere or at temperatures above, for example, 250° C. Conventional methods for preparing polyester resins such as PET may suffer from disadvantages associated with the need to carry out a solid state polymerization (SSP) which subjects the resin to a long heat history and/or may require high capital expenditure.

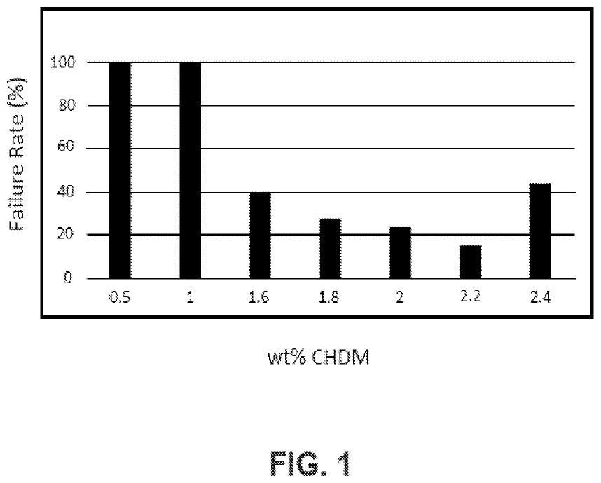

A conventional process for producing polyester resins for container applications including melt-phase polycondensation and solid-state polymerization is shown schematically in FIG. 1 wherein the monomer components of a polyester resin such as PET are mixed in a melt-phase esterification/polycondensation reactor. The reaction is carried out to provide a molten resin having an intrinsic viscosity (IV) of from 0.50 to 0.65. The molten product obtained by the melt-phase esterification/polycondensation is then subjected to a polymer filtration.

The melt-phase esterification/polycondensation is typically carried out in a plurality of reactors. Therefore, the monomers may be added to a first esterification reactor to form a low IV material. As the oligomers pass through the remaining reactors, the IV is subsequently raised as the polycondensation reaction proceeds sequentially through a series of reactors. The material in molten form is subjected to solidification and pelletizing. The molten material may be solidified by passage of strands or filaments of the material formed by pumping the material through, for example, a die with a series of orifices. As the molten polyester resin is passed through an orifice, a continuous strand is formed. By passing the strands through water, the strands are immediately cooled to form a solid. Subsequent cutting of the strands provides pellets or chips which, in a conventional process, are then transferred to a solid-state polymerization stage (i.e., SSP).

In conventional processes for preparing polyester resins and even in some processes which avoid the use of a solid-state polymerization after polymerization is complete, the molten polymerized resin may be pumped through a die to form multiple strands. The molten resin exiting from the die is quickly quenched in water to harden the resin. As a result of the quick cooling (e.g., water quench) the molten polyester does not have time to crystallize and is solidified in an amorphous state. Solidified polyester strands, or pellets derived from cut strands, are clear, transparent and in an amorphous state.

Solid-state polymerization (SSP) is an important step in some conventional processes used to manufacture high molecular weight polyester resins for bottle, food-tray, and tire-cord applications. The clear amorphous pellets (0.50 to 0.65 IV) produced by conventional melt polycondensation reaction processes may be further polymerized in the solid state at a temperature substantially higher than the resin's glass transition temperature but below the resin's crystalline melting point. The solid state polymerization is carried out in a stream of an inert gas (usually nitrogen under continuous operation) or under a vacuum (usually in a batch rotary vacuum dryer). At an appropriate SSP temperature, the functional end groups of the polymer (e.g., PET) chains are sufficiently mobile and react with one another to further increase the molecular weight.

The SSP may include several individual reactors and/or processing stations. For example, the SSP may include a pre-crystallization step wherein the chips and/or pellets are transformed from an amorphous phase into a crystalline phase. The use of a crystalline phase polyester resin is important in later steps of the SSP because the use of amorphous polyester chips may result in clumping of the pellets since an amorphous state polyester resin may not be sufficiently resistant to adherence between pellets and/or chips. The SSP process further includes a crystallizer (e.g., crystallization step), a pre-heater, a cooler, and an SSP reactor.

One of the disadvantages encountered is that typical PET resins produced by melt polymerization have an intrinsic viscosity (IV) of around 0.50 to 0.65. When the IV is raised further by SSP, there is an initial increase in IV (known as the “lift rate”), which begins to level out around an IV of 0.90 to 1.0. Even these IV levels take a long time to achieve with conventional resins under SSP, often approaching 24 to 48 hours of SSP time. This results in excessive heat history, elevated melting temperature, and often poor color characteristics, as well as high production costs due to the energy required and slow production.

The production of a polyester resin such as PET may be carried out directly from a melt phase of the monomer units without any final solid-state polymerization. For example, a batch process may be carried out at a sufficient temperature, for a sufficient time and at a sufficient pressure to drive the polycondensation reaction to completion thus avoiding the need for any subsequent finishing (e.g., final reaction).

Some manufacturing processes do not include an SSP. Processing a polyester resin directly from a melt phase condensation to obtain pre-forms for stretch blow molding applications is described in U.S. Pat. No. 5,968,429 (incorporated herein by reference in its entirety). The polymerization is carried out without an intermediate solidification of the melt phase and permits the continuous production of molded polyester articles (e.g., pre-forms), from a continuous melt phase reaction of the starting monomers.

The present invention copolyester composition may be made by a melt-phase reaction carried out in a plurality of reactors connected in series, in parallel, or in both series and parallel. The reaction of the dicarboxylic acid and diol monomers may be carried out in the absence of any solvent (e.g., a diluent component that does not form a substantial portion of the reacted polymer units in the resin composition). The monomer units are reacted to form a material having an intrinsic viscosity that may preferably range in one embodiment of the invention from 0.2 to 0.5 IV prior to the final finisher. The molten material thus formed in the melt-phase reactor is then pumped or transferred to a finishing reactor. The finishing reactor may be a reactor such as a wiped- or thin-film reactor which provides substantial contact between surface areas of the reactor and results in high mixing of the molten reacted melt-phase product. The finishing process may be carried out in one or more reactors connected in series, parallel, or both in series and parallel. In addition to the wiped-film reactor, one or more falling film or pipe reactors may be included. The resin product obtained from the last finishing reactor may have an intrinsic viscosity of from 0.65 to 0.9, preferably from 0.7 to 0.85, more preferably from 0.72 to 0.80, and especially preferably about 0.76.

The molten resin product obtained from the finishing reactor is then preferably subjected to a polymer filtration in the molten form. Polymer filtration may be carried out in one or more steps.

For the copolyester composition of the present invention, the polymerization of the monomer units is preferably carried out to provide a target intrinsic viscosity of from 0.65 to 0.9, more preferably from 0.7 to 0.85, even more preferably from 0.72 to 0.80, especially preferably about 0.76, prior to any solid state polymerization (SSP) process, which can bring the final product IV to ranges of 0.9 to 1.3 IV, preferably 1.0 to 1.2 IV.

After pre-crystallization, the chips and/or pellets may be subjected to a final crystallization. A final crystallization may include, for example, proper heating of the chips (pellets, pastilles, granules, round particles, etc.) at appropriate temperatures. Once the polyester resin is in a crystallized state, the pellets and/or chips are preheated and ready for transfer to the top of a counter-flow SSP reactor (parallel to the pre-heater) via a pneumatic system (e.g., Buhler technology). If a tilted crystallizer is stacked above the SSP reactor, the hot/crystallized chips then enter the SSP reactor by the rotating screw of the crystallizer (e.g., Sinco technology). The SSP reactor can be considered as a moving bed of chips that move under the influence of gravity. The chips have a slow down-flow velocity of from 30 to 60 mm/minute and the nitrogen has a high up-flow velocity of about 18 m/minute. A typical mass-flow ratio of nitrogen to PET is in the range of 0.4 to 0.6. In a gravity-flow reactor, the pellets and/or chips are subjected to elevated temperatures for periods of up to 15 hours. The heating and nitrogen sweeping through the gravity-flow reactor will drive the polycondensation reaction and result in longer chain lengths and, concurrently, a higher IV of the resins.

After passing through the gravity-flow reactor, pellets and/or chips of a wide range of IV can be formed, e.g., having an average IV of about 0.80-0.84 dL/g, e.g., for CSD/Beer. The pellets and/or chips have an opaque characteristic due to their crystallinity. The crystalline material is transferred to a product silo for storage and/or packaging. The finished product in a crystalline state and having an IV of about 0.80-84 dL/g, e.g., for CSD/Beer, can be further mixed with other co-barrier resins (powders, granules, pellets, pastilles, etc.) by molders or processors who purchase the polyester resins for manufacturing, for example, bottles and/or containers.

Thus, in a conventional process, a melt-phase polycondensation process may be used to make clear amorphous pellets (typically, 0.50 to 0.65 IV) as precursors to bottle resins. The amorphous pellets are first pre-crystallized, crystallized, and/or preheated, then subjected to SSP in a gravity flow reactor (e.g., a reactor that is not agitated). After crystallization, the resin pellets become opaque and do not stick together if the temperature of SSP is at least 10° C. below the onset of the melting temperature of the resin pellets. In a direct high IV melt process (such as detailed above and in U.S. Pat. No. 9,399,700, the contents of which are incorporated herein by reference in their entirety), only the melt process (no SSP) is used to make a variety of bottle resins (e.g., 0.72 to 0.78 IV for water bottles, 0.81 to 0.87 IV for CSD/Beer bottles) as desired. In a direct high IV melt process, a finisher (e.g., a wiped- or thin-film evaporator) may be used to effectively and rapidly remove the reaction by-products such as EG (major), water, acetaldehyde, and so on. Immediate removal of EG/water under high temperatures drives the polycondensation reaction equilibrium toward the polymer side.

PET or other polyester resins are known to have hygroscopic behavior (e.g., absorb water from the atmosphere), so pellets obtained by cutting water-quenched strands contain significant quantities of water. Conventionally, the pellets may be dried by passing dry air over the pellets or by heating. Heating for an extended period at an elevated temperature may lead to problems because the amorphous polyester (e.g., PET) pellets may have a tendency to stick to one another.

The present invention copolyester composition can be processed by any method of processing a resin, e.g., by melting the resin, forming a shaped article from the molten resin, and cooling the shaped article to form a solid shaped article. Processing includes any method by which the polyester resin is transformed from a solid form to a flowable and/or plastic form. The transforming may include heating the polyester resin beyond the glass transition temperature then forming a shaped solid article from the heated polyester resin. Processing further includes any method by which a solid polyester resin is heated above its glass transition temperature and/or melt temperature and is subsequently and/or concurrently formed into a shaped article, particularly those processes that require the use of a high melt strength resin, including: injection molding, reaction injection molding (RIM), stretch blow molding, injection blow molding, recycling, extrusion molding (including EBM), compression molding, thermoforming, and such methods for processing polyester resins as described in “PET Packaging Technology,” by David W. Brooks and Geoff Giles (2002), the portions of which describe processing methods for polyester resins and/or PET resins are incorporated herein by reference. Preferred processing includes injection (blow) molding and extrusion blow molding (EBM); most preferably EBM.

The blow molding (either injection blow molding or extrusion blow molding) process begins with melting down the plastic and forming it into a parison or preform. The parison is a tube-like piece of plastic with a hole in one end in which compressed air can pass through.

The basic process has two fundamental phases. First, a preform (or parison) of hot plastic resin, often in a somewhat tubular shape, is created. Second, a pressurized gas, usually air, is used to expand the hot preform and press it against a mold cavity. The pressure is held until the plastic cools. This action identifies another common feature of blow molded articles. Part dimensional detail is better controlled on the outside than on the inside, where material wall thickness can alter the internal shape. Once the plastic has cooled and hardened the mold opens up and the part is ejected.

The extrusion blow molding (EBM) process is the most common process for producing plastic bottles, particularly large plastic bottles. The basic extrusion blow molding process comprises plasticizing or melting of the resin in an extruder, forming the parison by extrusion of the molten resin through a die into a mold, blowing the parison to fit the shape of the bottle mold and cooling, then deflashing of the blown bottle and ejection of the finished product. Variations can include multiple extruders for coextrusion of two or more materials for multilayer bottle structures, parison programmer to shape the parison to match complex blown product shapes and wall thickness, and multiple mold clamp systems to improve output through the use of multiple molds.

In the EBM process, an extruder melts, mixes, and feeds a homogeneous molten polymer into a die head that forms the molten hollow plastic tube, called a parison, used in blowing hollow containers or other hollow products. The first step is extrusion of a hollow plastic parison which is usually in a downward direction for making bottles. Next, the two halves of the mold close on the parison, capturing it as it is cut off from the extruder by a cold or heated cut-off knife. A blow pin or a needle is inserted and air is blown into the mold, expanding the parison. In some cases the blown pin cooled by water, assists in forming the thread finish by compressing the thread finish section into the mold (neck calibration), rather than simply blowing it in. This results in a smooth interior in the finish region. In the needle blow case, the needle is inserted into a part of the molded object that is trimmed off forming the final container shape, and the inside of the finish is formed only by air. The mold is cooled, usually with water, to solidify the plastic. When the container is cool enough to maintain its shape, it is ejected from the mold.

The flash is trimmed from the container neck and bottom, as well as from other areas that are pinched off, for instance to form handles or offset necks. The mark left from the removal of the flash serve as an easy means for identification of extrusion blow-molded containers. Usually, this is easiest to see on the bottom of the container. It typically appears as a rough area along the mold parting line, centered in the middle of the bottom and running half or so of the distance to the heel of the bottle. It is also possible, on careful examination, to identify the roughness at the top of the finish, or on other areas where flash was trimmed.

The flash, after being trimmed, is usually granulated in a closed-loop fashion with the extruder and is immediately fed back into the drying hoppers on the extruder at a controlled rate, mixed with the virgin resin. The use of regrind can be problematic for heat-sensitive resins like PVC, and for highly modified PET polymers as noted above, especially if the proportion of the flash is high. However, with the present invention copolyester composition, there is no practical limit for regrind levels because it is a thermally stable resin.

There are two main categories of extrusion blow molding processes: continuous and intermittent.

In continuous EBM, the parison is extruded continuously and the individual parts are cut off by a suitable knife. Types of equipment for continuous EBM may be categorized as follows: rotary wheel blow molding systems and shuttle machinery. Examples of parts made by the EBM process include dairy containers, shampoo bottles, hoses/pipes, and hollow industrial parts such as drums.

Intermittent extrusion blow molding may be also called shot extrusion. Parison shot extrusion is accomplished by means of a reciprocating screw almost identical to those used in injection molding machines. In intermittent blow molding there are two main types of processes: straight intermittent is similar to injection molding whereby the screw turns, then stops and pushes the melt out. With the accumulator method, an accumulator gathers melted plastic and when the previous mold has cooled and enough plastic has accumulated, a rod pushes the melted plastic and forms the parison. In this case the screw may turn continuously or intermittently.

The processing may be carried out on a polyester resin that is dried or undried. A dried polyester resin is a crystallized resin that has been heated in its solid state to a temperature above the glass transition temperature in a dehumidifying environment. A dried polyester resin contains less than 1,000 ppm, preferably less than 500 ppm, more preferably less than 50 ppm, especially preferably less than 25 ppm of water based upon the weight of the water relative to the total weight of the resin. Drying may also be accomplished by exposing the polyester resin to a dehumidified atmosphere to thereby remove water adsorbed or absorbed by the polyester resin.

Undried polyester resin may be a polyester resin that contains water or a resin that is free of water. A resin that is free of water may be one that is obtained by solidifying a polyester resin liquid obtained directly from a polyester polymerization process in an atmosphere that is substantially free of water (e.g., substantially free of water includes atmospheres that have 99%, preferably 99.5%, more preferably 99.9% by volume free of water vapor). Thus, an undried polyester resin may be one that has not undergone heating in the solid state.

An undried polyester resin may be one that is obtained in the solid form from a polyester polymerization process then stored in an atmosphere that is not inert and/or not dried (e.g., dehumidified). Water vapor present in the atmosphere may absorb onto the surface of the polyester resin and/or may absorb into the matrix of the polyester resin. An amount of water of as much as 5% by weight based upon the weight of the water relative to the total weight of the resin may be present. Preferably, the polyester resin used in the method of the invention is an undried water-free resin or a dried resin.

The process of extruding a parison can be continuous or intermittent. For intermittent extrusion, the melt from the continuously rotating extruder may be fed into an accumulator, from which it is periodically ejected, or a reciprocating extruder like those used for injection molding may be used. Continuous extrusion is preferred for most packaging applications. It provides higher productivity and reduces thermal degradation, since the melt is not held up. Intermittent extrusion is commonly used for the production of very large blown containers, where a large parison must be produced in a very short time, and in the production of gasoline tanks for automobiles.

The bottle parison may be blown into a straight wall mold or into shaped and/textured molds and of all sizes may be used without restriction. One bottle form is a two-liter or larger laundry detergent bottle. Another form is a one-gallon juice bottle.

The container formed from the present invention copolyester parison is preferably free of haze, particularly in light of the controlled lower levels of IPA and/or CHDM comonomers in the present invention copolyester and little or no other comonomers or additives. The temperature of the extruded parison may be adjusted so that haze is not observed in the EBM article. A parison temperature that is too low during EBM may result in unacceptable material distribution whereas a parison temperature that is too high may result in haze or unacceptable material distribution.

The measurement method for determining solution intrinsic viscosity (IV) of polyester (e.g., PET) resins is conventionally known. Solution IV can be measured at 0.50% concentration of the resin in a 60/40 (wt. %/wt. %) phenol/1,1,2,2-tetrachloroethane solution by means of a glass capillary viscometer. Conditions for measuring solution IV are described in ASTM D 4603-18 (approved on Jun. 14, 2018, incorporated herein by reference in its entirety).

The glass transition temperature of the polyester resin used as a starting material (hereafter “starting material resin”) in the invention is not restricted and may be defined or influenced by the degree of polymerization and/or co-monomer content of the polyester resin (e.g., the number of polymerized monomer units making up the polymer chain) and/or the molecular weight distribution of a mixture of different polymers of different polymerization degree (polydispersity) and/or the identity and quantity of the monomer or co-monomer units of the polyester resin. Preferably a polyester resin having a narrower molecular weight distribution is used because it may show less degradation and a more stable IV upon processing than a polyester resin having a broad molecular weight distribution.

The glass transition temperature (Tg) of the starting material resin is preferably from 75 to 90° C., more preferably from 80 to 85° C. and most preferably about 82° C. The Tg of resin compositions containing additives may have glass transition temperatures higher or lower than those mentioned above by as much as 5° C.

One embodiment of the present invention provides a copolyester comprising a diacid/diester component comprising from 1 to 30 mole % isophthalic units, and from 70 to 99 mol % terephthalic units, based on total diacid/diester component, and a diol component comprising from 1 to 15 mole % 1,4-cyclohexanedimethanol (CHDM), and from 82 to 99 mole % ethylene glycol, and from 0 to 3 mole % diethylene glycol (DEG), based on total diol component.

In certain embodiments of the present invention, the copolyester has isophthalic units present in an amount of preferably from 15 to 28 mol %, more preferably from 20 to 25 mol %, based on total diacid/diester component.

In certain embodiments of the present invention, the copolyester has units obtained from CHDM present in an amount of preferably from 5.0 to 10.0 mol %, more preferably from 6.0 to 9.0 mol %, based on total diol component.

In certain embodiments of the present invention, the copolyester has isophthalic units in an amount of from 20 to 25 mol %, based on total diacid/diester component, and units obtained from CHDM present in an amount of from 6.0 to 9.0 mol %, based on total diol component. In preferred embodiments, the amount of isophthalic units and amount of terephthalic units total 100 mol % of the total diacid/diester component of the copolyester of the present invention, and/or the amount of units obtained from ethylene glycol and amount of units obtained from CHDM total 100 mol % of the total diol component. In other embodiments, the diol component may comprise up to 3 mol % of units from diethylene glycol (DEG), either by addition of an amount of DEG as a starting material, or by the production of the DEG as a byproduct during the esterification/polymerization process.

The copolyester of the present invention can be prepared using any conventional catalysts used in polyester production, particularly PET production, and is preferably prepared using a catalyst selected from the group consisting of antimony compounds, titanium compounds, germanium compounds, zinc compounds, and combinations thereof.

In certain embodiments, the copolyester of the present invention has a glass transition temperature (Tg) of from 75 to 90° C., preferably from 80 to 85° C.

In certain embodiments, the copolyester of the present invention demonstrates an oxygen transmission rate of from 0.80 to 1.35 cc/m²/24 h, as measured in accordance with ASTM D3985.

In preferred embodiments of the present invention copolyester, the copolyester contains no added crosslinking agent or other additives, and particularly contains no additives having 3 or more functional groups that can act as a crosslinking agent.

Articles produced from the copolyesters of embodiments of the present invention have improved drop properties as measured according to ASTM D2463. These articles can be prepared by injection blow molding or extrusion blow molding (EBM), and preferably are prepared by EBM. Such articles can be any blow molded article, including, but not limited to, bottles and medical tube containers.

Having generally described this invention, a further understanding can be obtained by reference to certain specific examples which are provided herein for purposes of illustration only and are not intended to be limiting unless otherwise specified.

### Examples

Various copolyesters were prepared and subjected to injection molding to produce 40-mil plaques for drop impact testing in accordance with ASTM-D3763 testing. Copolyesters were prepared having the compositions noted in Table 1 below (PTA=terephthalic acid; IPA=isophthalic acid; CHDM=1,4-cyclohexanedimethanol; CHDA=1,4-cyclohexane dicarboxylic acid; PEG=polyethylene glycol):

TABLE 1
Impact Strength (D3763) and OTR

| | | | | | | | Oxygen |
|---|---|---|---|---|---|---|---|
| | | | | | | ASTM | Transmission |
| | wt % Acids | | | | | D3763 | Rate |
| | | | Succinic | Adipic | wt % | Failure | cc · mil/(100 |
| ID | PTA | IPA | Acid | Acid | Polymer | Type | in2 · day) |
| Example 1 | 100% | 0% | | | 2.6 wt % | Ductile | 1.77 |
| | | | | | CHDM | | |
| Example 2 | 75% | 25% | | | | Brittle | 0.84 |
| Example 3 | 75% | 25% | | | 2.5 wt % | Brittle | 0.73 |
| | | | | | CHDA | | |
| Example 4 | 75% | 25% | | | 2.6 wt % | Ductile | 0.80 |
| | | | | | CHDM | | |
| Example 5 | 80% | 20% | | | 2.0 wt % | Ductile | 0.98 |
| | | | | | 1,4-CHDM | | |
| Example 6 | 80% | 20% | | | 3.0 wt % | Ductile | 1.34 |
| | | | | | 1,4-CHDM | | |
| Example 7 | 75% | 20% | 5% | | | Brittle | — |
| Example 8 | 75% | 20% | | 5% | | Brittle | — |
| Example 9 | 75% | 25% | | | 1.5% | Brittle | — |
| | | | | | PEG 200 | | |

Example 1 is a comparative example containing 2.6 wt % CHDM and no IPA in the copolyester formed. Example 2 is a comparative example containing 25 wt % of IPA but no CHDM units. Example 3 is a comparative example containing 25 wt % of IPA, where there are 2.5 wt % of cyclohexanedimethylenyl groups obtained from the use of CHDA (a diacid component) instead of CHDM (a diol component). Examples 4-6 are examples of embodiments of the copolyester of the present invention containing varying amounts of IPA and/or CHDM. Examples 7 and 8 are comparative examples containing 20 wt % of IPA and 5 wt % of either succinic acid (Ex. 7) or adipic acid (Ex. 8). Example 9 is a comparative example containing 25 wt % of IPA and 1.5% of PEG 200.

As shown in Table 1, while Example 1 had acceptable impact strength under ASTM D3763 testing, the oxygen barrier properties were too poor permitting too much oxygen transmission. The Example 2 formulation used high IPA for good barrier properties, but resulted in a product that was brittle. This lack of flexibility would limit its use in applications requiring the material to withstand physical stress or impact. These findings suggest a trade-off between ductility and oxygen barrier properties in the polymer compositions tested. Examples 3, 7, 8, and 9 all used different comonomers than CHDM in combination with IPA. However, these alternatives did not improve the impact properties of the final product. Present invention Examples 4, 5, and 6 provided a copolyester that combines CHDM with IPA in the copolyester. This combination at low levels of CHDM was found to maintain good barrier properties and also improved the impact performance of the product, thus offering a solution to improve impact resistance without compromising barrier properties.

The impact performance data in accordance with ASTM-D3763 was further tested comparing Example 2 (comparative example) and Example 5 (an embodiment of the present invention copolyester). The results are provided in Table 2 below:

TABLE 2
Impact Strength (D3763)

| | | | | Average | | | | |
|---|---|---|---|---|---|---|---|---|
| | | | | Deflection | Average | Average | Average | Average |
| | | Failure | | at Peak | Peak | energy | Puncture | Total |
| | Failure | Rate | Thickness | Load | Load | at Peak | Energy | Energy |
| ID | Type | (%) | (mm) | (mm) | (N) | Load (J) | (J) | (J) |
| Example 2 | Brittle | 100 | 1.62 | 4.1 | 316 | 0.5 | 0.6 | 0.6 |
| Example 5 | Ductile | 24 | 1.61 | 13.8 | 1925 | 12.2 | 19.1 | 19.3 |

This data of Table 2 shows significant improvements in impact strength using the copolyester of an embodiment of the present invention compared to a typical high-IPA level polyester.

Polymer plaques (70-mil) were prepared from copolyesters having IPA and from 0.5 wt % to 2.4 wt % of CHDM, and tested for impact strength in accordance with ASTM-D3763. The results are presented in FIG. 1, which show that embodiments of the present invention copolyesters having from 1.8 wt % to 2.2 wt % of CHDM provide significantly better impact strength performance.

A copolyester of an embodiment of the present invention having 3 wt % IPA and 2 wt % CHDM was produced and solid state polymerized to reach an intrinsic viscosity (IV) of 1.1. Bottles (128 oz) were then produced from this resin using EBM and compared with EBM-5860 commercial resin as control. The resulting bottles were impact strength tested using the Bruceton Staircase Method (which method is hereby incorporated in its entirety by reference) and the results are shown in Table 3 below.

TABLE 3
Impact Strength (Bruceton Staircase Method) [symbol]
128 oz bottles were produced for the drop impact testing
Bottles Produced via Wheel Technology (50/50 Virgin/Regrind)

| | | EBM-5860 (1.1 IV) | | | Example 10 (1.1 IV) | | |
|---|---|---|---|---|---|---|---|
| | | Mean | | | Mean | | |
| | | Failure | Min | Max | Failure | Min | Max |
| Aging | | Height | Failure | Pass | Height | Failure | Pass |
| Time | | (MFH), ft | Height, ft | Height, ft | (MFH), ft | Height, ft | Height, ft |
| Fresh | | 2.21 | 2 | 3.5 | 5.25 | 4 | 6 |
| 72 | Hr | 2.4 | 2 | 3.5 | 4.93 | 4 | 6.5 |
| 1 | Week | 1.8 | 2 | 2.5 | 5.13 | 4.5 | 5.5 |
| 2 | Week | 2.52 | 2 | 3 | 4.57 | 4 | 5.5 |
| 4 | Week | 1.96 | 2 | 3 | 4.13 | 3 | 5 |
| 8 | Week | 1.81 | 2 | 2.5 | 4.71 | 4 | 5 |

As shown in Table 3, the copolyester of an embodiment of the present invention provided reduced number of failures during drop impact testing using both fresh and aged bottles. The mean failure height increased by approximately a factor of 2 compared to the EBM-5860 commercial control resin.

The following are exemplary embodiments of the present invention:

Embodiment 1. A copolyester comprising:
a diacid/diester component comprising from 70 to 99 mol % terephthalic units and from 1 to 30 mole % of non-terephthalic based diacid/diester units, based on total diacid/diester component, and
a diol component comprising from 1 to 15 mole % of a diol containing a cyclohexylene group, and from 82 to 99 mole % ethylene glycol, and from 0 to 3 mole % diethylene glycol (DEG), based on total diol component.

Embodiment 2. The copolyester of Embodiment 1, wherein the non-terephthalic based diacid/diester units are isophthalic units.

Embodiment 3. The copolyester of Embodiment 2, wherein the isophthalic units are present in an amount of from 15 to 28 mol %, based on total diacid/diester component.

Embodiment 4. The copolyester of one of Embodiment 2 or Embodiment 3, wherein the isophthalic units are present in an amount of from 20 to 25 mol %, based on total diacid/diester component.

Embodiment 5. The copolyester of any one of Embodiments 1 to 4, wherein the diol containing a cyclohexylene group is a unit obtained from cyclohexanedimethanol (CHDM).

Embodiment 6. The copolyester of Embodiment 5, wherein the CHDM is present in an amount of from 5.0 to 10.0 mol %, based on total diol component.

Embodiment 7. The copolyester of one of Embodiment 5 or Embodiment 6, wherein the CHDM is present in an amount of from 6.0 to 9.0 mol %, based on total diol component.

Embodiment 8. The copolyester of any one of Embodiments 2 to 7, wherein the amount of isophthalic units and amount of terephthalic units total 100 mol % of the total diacid/diester component.

Embodiment 9. The copolyester of any one of Embodiments 5 to 8, wherein the amount of CHDM and amount of ethylene glycol total 100 mol % of the total diol component.

Embodiment 10. The copolyester of any one of Embodiments 1 to 9, wherein the diol component may further comprise up to about 3 mol % of diethylene glycol (DEG).

Embodiment 11. The copolyester of any one of Embodiments 1 to 10, wherein the composition is prepared using a catalyst selected from the group consisting of antimony compounds, titanium compounds, germanium compounds, zinc compounds, and combinations thereof.

Embodiment 12. The copolyester of any one of Embodiments 1 to 11, wherein the copolyester has a glass transition temperature (Tg) of from 75 to 90° C.

Embodiment 13. The copolyester of any one of Embodiments 1 to 12, wherein the copolyester has a glass transition temperature (Tg) of from 80 to 85° C.

Embodiment 14. The copolyester of any one of Embodiments 1 to 13, wherein the copolyester contains no added crosslinking agent or additive having 3 or more functional groups.

Embodiment 15. A article having improved drop impact properties as measured according to ASTM D2463, wherein the article is prepared from the copolyester of any one of Embodiments 1 to 14.

Embodiment 16. The article of Embodiment 15, wherein the article is prepared by injection blow molding.

Embodiment 17. The article of Embodiment 15, wherein the article is prepared by extrusion blow molding.

Embodiment 18. The article of any one of Embodiments 15 to 17, wherein the article is a bottle.

Embodiment 19. The article of any one of Embodiments 15 to 17, wherein the article is a medical tube container.

Embodiment 20. A method for preparing the copolyester of any one of Embodiments 1 to 14, comprising:
a) reacting the diacid/diester components and the diol components in an esterification/transesterification reactor to form a first reaction mixture, and
b) polymerizing the first reaction mixture in a polymerization reactor to form the copolyester.

Embodiment 21. The method of Embodiment 20, wherein the method is performed in a batchwise manner.

Embodiment 22. The method of Embodiment 20, wherein the method is performed in a continuous manner.

Obviously, numerous modifications and variations of the present invention are possible in light of the above teachings. It is therefore to be understood that within the scope of the appended claims, the invention may be practiced otherwise than as specifically described herein.

1. A copolyester comprising:
a diacid/diester component comprising from 70 to 99 mol % terephthalic units and from 1 to 30 mole % non-terephthalic based diacid/diester units, based on total diacid/diester component, and
a diol component comprising from 1 to 15 mole % of a diol containing a cyclohexylene group, and from 82 to 99 mole % ethylene glycol, and from 0 to 3 mole % diethylene glycol (DEG), based on total diol component.

2. The copolyester of claim 1, wherein the non-terephthalic based diacid/diester units are isophthalic units.

3. The copolyester of claim 2, wherein the isophthalic units are present in an amount of from 15 to 28 mol %, based on total diacid/diester component.

4. The copolyester of claim 2, wherein the isophthalic units are present in an amount of from 20 to 25 mol %, based on total diacid/diester component.

5. The copolyester of claim 1, wherein the diol containing a cyclohexylene group is a unit obtained from cyclohexanedimethanol (CHDM).

6. The copolyester of claim 5, wherein the CHDM is present in an amount of from 5.0 to 10.0 mol %, based on total diol component.

7. The copolyester of claim 5, wherein the CHDM is present in an amount of from 6.0 to 9.0 mol %, based on total diol component.

8. The copolyester of claim 2, wherein the amount of isophthalic units and amount of terephthalic units total 100 mol % of the total diacid/diester component.

9. The copolyester of claim 5, wherein the amount of CHDM and amount of ethylene glycol total 100 mol % of the total diol component.

10. The copolyester of claim 1, wherein the diol component may further comprise up to about 3 mol % of diethylene glycol (DEG).

11. The copolyester of claim 1, wherein the composition is prepared using a catalyst selected from the group consisting of antimony compounds, titanium compounds, germanium compounds, zinc compounds, and combinations thereof.

12. The copolyester of claim 1, wherein the copolyester has a glass transition temperature (Tg) of from 75 to 90° C.

13. The copolyester of claim 1, wherein the copolyester has a glass transition temperature (Tg) of from 80 to 85° C.

14. The copolyester of claim 1, wherein the copolyester contains no added crosslinking agent or additive having 3 or more functional groups.

15. A article having improved drop impact properties as measured according to ASTM D2463, wherein the article is prepared from the copolyester of claim 1.

16. The article of claim 15, wherein the article is prepared by injection blow molding.

17. The article of claim 15, wherein the article is prepared by extrusion blow molding.

18. The article of claim 15, wherein the article is a bottle.

19. The article of claim 15, wherein the article is a medical tube container.

20. A method for preparing the copolyester of claim 1, comprising:
a) reacting the diacid/diester component and the diol component in an esterification/transesterification reactor to form a first reaction mixture, and
b) polymerizing the first reaction mixture in a polymerization reactor to form the copolyester.

21. The method of claim 20, wherein the method is performed in a batchwise manner.

22. The method of claim 20, wherein the method is performed in a continuous manner.
